(19) United States
(12) Patent Application Publication
(10) Pub. No.: US 2003/0072225 A1
(43) Pub. Date: Apr. 17, 2003

(54) Optical disk device, and method of controlling such optical disk device

(76) Inventor: Junji Tada, Ehime (JP)

Correspondence Address: WENDEROTH, LIND & PONACK, L.L.P., 2033 K STREET N. W., SUITE 800, WASHINGTON, DC, 20006-1021, US

(21) Appl. No.: 09/937,140

(22) PCT Filed: Jan. 24, 2001
(86) PCT No.: PCT/JP01/00427

(30) Foreign Application Priority Data
Jan. 24, 2000 (JP) 2000-14862

(51) Int. Cl. G11B 7/00

(52) U.S. Cl. 369/44.29; 369/53.3; 369/47.4

(57) ABSTRACT

There is provided an optical disk drive for playing or playing and recording an optical disk, and a method for controlling the optical disk drive, wherein, while the rpm of a spindle motor (11) is changed, the spindle motor (11) is controlled according to FG servo by a second spindle motor controller (23), and tracking servo by a tracking controller (18) is turned off.

### TECHNICAL FIELD

The present invention relates to an optical disk drive for playing or playing and recording an optical disk, and a method for controlling the optical disk drive.

### BACKGROUND ART

There have conventionally been known optical disk drives for playing or playing and recording optical disks such as CD-ROM (Compact Disc Read Only Memory), CD-R (CD-Recordable), CD-RW (CD Re-Writable) and the like, and an example of such optical disk drive is disclosed in, for example, Japanese Published Patent Application No. Hei.11-120687.

This optical disk drive is provided with a spindle motor as a motor for rotationally driving an optical disk when performing recording/playback of the optical disk. Control of the rpm (revolutions per minute) of this spindle motor is called “spindle servo”. There are three kinds of spindle servos as follows: WOBBLE servo utilizing a WOBBLE signal which is read from a blank optical disk by an optical pickup; EFM servo utilizing an EFM (Eight to Fourteen Modulation: 8/14 modulation) signal which is read from an already-recorded optical disk by an optical pickup; and FG servo utilizing an FG (Frequency Generator) signal detected from a Hall element which is mounted in the vicinity of the spindle motor as a means for detecting the rpm of the spindle motor. The WOBBLE servo to be executed on a blank optical disk and the EFM servo to be executed on an already-recorded optical disk are used for controlling the spindle motor when the spindle motor rotates the optical disk at a constant speed. On the other hand, the FG servo is switched from the WOBBLE servo or the EFM servo when the rpm of the optical disk should be changed while the optical disk is rotating, and it is used for controlling the rpm while the rpm is changed.

Hereinafter, a description will be given of the control operation of the conventional optical disk drive when it changes the rpm of the spindle motor, with reference to a flowchart shown in FIG. 6. In the flowchart, an initialization step to be carried out immediately after start-up, such as preparation for controlling the spindle motor by the FG servo, will be omitted. It is assumed that, before the change, the rpm of the optical disk is kept constant by the WOBBLE servo or EFM servo.

Initially, a target frequency of the FG signal corresponding to a target rpm is calculated (step S60), and the calculated target frequency is set (step S61). Next, the spindle servo mode is switched from the WOBBLE servo or EFM servo to the FG servo (step S62), and the FG servo is executed (step S63). Thereby, revolution of the spindle motor is accelerated or decelerated toward the target rpm. Next, it is checked whether the spindle motor has reached the target rpm or not, on the basis of the FG signal obtained from the Hall element (step S64). When the spindle motor has reached the target rpm, the spindle servo is returned to the state before step 62, that is, the state where control is carried out by the WOBBLE servo or EFM servo (step S65). In this way, the rpm of the optical disk is changed.

As described above, in the conventional optical disk drive, since the FG servo is employed when changing the rpm of the optical disk, the time required until the rpm of the spindle motor is stabilized when it is changed can be reduced and uniformalized.

By the way, the WOBBLE servo to be executed on a blank optical disk and the EFM servo to be executed on an already-recorded optical disk are carried out on the basis of a signal which is read from the optical disk by an optical pickup. Therefore, while these spindle servos are carried out, tracking servo for making a laser beam emitted from the lens of the optical pickup follow grooves formed on the optical disk in the direction of the radius of the optical disk, and focusing servo for making the laser beam follow the grooves in the direction of the rotation axis of the optical disk, must be carried out.

In the conventional optical device, however, in the state where the tracking servo and the focusing servo are carried out, the spindle servo is switched from the WOBBLE servo or EFM servo to the FG servo to change the rpm of the spindle motor. Accordingly, even while the rpm is changed, the laser beam emitted from the optical pickup follows the grooves formed on the optical disk in the direction of the radius of the optical disk, whereby the tracking position after changing the rpm of the spindle motor is deviated from that before the change.

For example, in an optical disk where a recorded area and a blank area coexist, if the rpm of the optical disk is changed in the vicinity of the boundary of these areas by using the an conventional optical disk drive, there may occur a change in tracking positions before and after the rpm change. As the result, the state of the optical disk at the tracking position, that is, whether data has already been recorded in the tracking position or not, may be changed. In this case, the optical disk drive may make an error in setting the spindle servo after the spindle motor has reached the target rpm, and the spindle servo may become uncontrollable, resulting in difficulties in performing stable recording/playback operation.

Furthermore, since the tracking position is changed when the rpm of the spindle motor is changed, it takes time to bring the optical pickup back to the tracking position before the rpm change, and the transition from the process of changing the rpm of the optical disk to the process of making the optical disk rotate at a constant rpm is not carried out smoothly, resulting in difficulties in performing stable recording/playback operation.

The present invention is made to solve the above-described problems and has for its object to provide an optical disk drive in which no change occurs in tracking positions before and after changing the rpm of an optical disk, and a method for controlling the optical disk.

### DISCLOSURE OF THE INVENTION

An optical disk drive according to the present invention comprises a motor for rotationally driving an optical disk; a pickup for reading a signal from the optical disk, the pickup being mounted movably with respect to the optical disk; a rpm detector for detecting the rpm of the motor; a tracking control means for performing tracking servo of the pickup on the basis of the signal which is read by the pickup; a first motor control means for detecting the rpm of the motor from the signal read by the pickup, and controlling the rpm of the motor on the basis of the detected rpm; a second motor control means for controlling the rpm of the motor on the basis of the rpm which is detected by the rpm detector; and a control means for, when the rpm of the motor is to be kept constant, making the first motor control means perform a control for keeping the rpm of the motor constant, and making the tracking control means perform the tracking servo of the pickup, and when the rpm of the motor is to be changed, the control means making the second motor control means perform a control for changing the rpm of the motor, and making the tracking control means turn off the tracking servo of the pickup while the rpm is being changed. Therefore, it is possible to provide an optical disk device which is able to change the rpm of the motor without moving the tracking position of the pickup.

Further, according to the present invention, in the above-described optical disk drive, the control means turns off the tracking servo performed by the tracking control means, after the motor rpm control is switched from the control by the first motor control means to the control by the second motor control means. Therefore, the tracking servo is turned off after the motor control is changed to the control which does not need the tracking servo, thereby providing an optical disk drive capable of stable recording/playback operation.

Further, according to the present invention, the above-described optical disk drive further comprises a focusing control means for performing focusing servo of the pickup on the basis of the signal which is read by the pickup, and the control means makes the focusing control means perform the focusing servo of the pickup when the rpm of the motor is to be kept constant or when the rpm of the motor is to be changed. Therefore, the focusing servo is surely carried out when the tracking servo is resumed after changing the rpm of the motor, thereby providing an optical disk drive capable of resuming the tracking servo speedily.

Further, according to the present invention, the above-described optical disk drive further comprises a focusing control means for performing focusing servo of the pickup on the basis of the signal which is read by the pickup, and when the rpm of the motor is to be kept constant, the control means makes the focusing control means perform the focusing servo of the pickup, and when the rpm of the motor is to be changed, the control means decides whether the focusing control means should perform the focusing servo or turn off the focusing servo while the rpm is being changed, according to the condition of the rpm of the optical disk, and then instructs the focusing control means to perform the decided operation. Therefore, it is possible to provide an optical disk drive which can realize a reduction in the load on the actuator as means for driving the pickup in the direction of the rotation axis of the motor, without increasing the process and time required for turn-off and resumption of the focusing servo.

Further, according to the present invention, in the above-described optical disk drive, the control means decides whether the focusing control means should perform the focusing servo or turn off the focusing servo, on the basis of the absolute value of a difference between the rpm of the motor before being changed and the target rpm. Therefore, it is possible to provide an optical disk drive which can appropriately perform a decision as to whether the focusing servo should be turned off or not, according to the rotation state of the motor.

Further, according to the present invention, in the above-described optical disk drive, the control means decides whether the focusing control means should perform the focusing servo or turn off the focusing servo, on the basis of the time required for changing the rpm of the motor. Therefore, it is possible to provide an optical disk drive which can appropriately perform a decision as to whether the focusing servo should be turned off or not, according to the rotation state of the motor.

Further, according to the present invention, an optical disk drive comprises a motor for rotationally driving an optical disk; a pickup for reading a signal from the optical disk, the pickup being mounted movably with respect to the optical disk; a rpm detector for detecting the rpm of the motor; a focusing control means for performing focusing servo of the pickup on the basis of the signal which is read by the pickup; a first motor control means for detecting the rpm of the motor from the signal read by the pickup, and controlling the rpm of the motor on the basis of the detected rpm; a second motor control means for controlling the rpm of the motor on the basis of the rpm detected by the rpm detector; and a control means for, when the rpm of the motor is to be kept constant, making the first motor control means perform a control for keeping the rpm of the motor constant, and making the focusing control means perform the focusing servo of the pickup; and when the rpm of the motor is to be changed, the control means making the second motor control means perform a control for changing the rpm of the motor, and making the focusing control means to turn off the focusing servo of the pickup while the rpm is being changed. Therefore, it is possible to provide an optical disk drive which can change the rpm of the motor without moving the tracking position of the pickup, and reduce the load on the actuator as means for driving the pickup in the direction of the rotation axis of the motor.

Further, according to the present invention, in the above-described optical disk drive, the control means turns off the focusing servo performed by the focusing control means after the motor rpm control is switched from the control by the first motor control means to the control by the second motor control means. Therefore, it is possible to provide an optical disk drive capable of stable recording/playback operation.

Further, according to the present invention, the above-described optical disk drive further comprises a tracking control means for performing tracking servo of the pickup on the basis of the signal which is read by the pickup, and when the rpm of the motor is to be kept constant, the control means makes the tracking control means perform the tracking servo of the pickup, and when the rpm of the motor is to be changed, the control means switches the motor control from the control by the first motor control means to the control by the second motor control means, and then makes the tracking control means turn off the tracking servo of the pickup and, thereafter, makes the focusing control means turn off the focusing servo. Therefore, it is possible to provide an optical disk drive which can change the rpm of the motor without moving the tracking position.

Further, according to the present invention, in the above-described optical disk drive, the control means makes the focusing control means turn off the focusing servo when the rpm of the motor is to be changed, and makes the focusing control means resume the focusing servo before the motor reaches the target rpm. Therefore, the focusing servo is performed at the point of time when the optical disk reaches the target rpm, thereby providing an optical disk drive which can reduce the time required for changing the rpm of the optical disk.

Further, according to the present invention, in the above-described optical disk drive, the control means sets a point of time when the focusing control means should start the focusing servo, at a point of time when the rpm of the motor being changed is equal to a rpm which is obtained by multiplying the target rpm by a predetermined number and is positioned between the rpm before being changed and the target rpm. Therefore, the focusing servo is performed at the point of time when the optical disk reaches the target rpm, whereby the time required for changing the rpm of the optical disk is reduced.

Further, according to the present invention, in the above-described optical disk drive, the control means decides the point of time when the focusing control means should start the focusing servo, on the basis of the time required until the rpm of the motor reaches the target rpm. Therefore, the focusing servo is surely performed at the point of time when the optical disk reaches the target rpm, whereby the time required for changing the rpm of the optical disk is reduced.

Further, according to the present invention, there is provided a method for controlling an optical disk drive comprising a motor for rotationally driving an optical disk, a pickup for reading a signal from the optical disk, which is mounted movably with respect to the optical disk, and a rpm detector for detecting the rpm of the motor, and the optical disk drive performing tracking servo of the pickup and controlling the rpm of the motor on the basis of the signal read by the pickup when the optical disk is to be rotated at a constant rpm; and when the rpm of the optical disk is to be changed, the optical disk drive control method comprises a step of switching the motor rpm control from a control based on the signal read by the pickup to a control based on the rpm of the motor which is detected by the rpm detector; a step of turning off the tracking servo; a step of changing the rpm of the motor so that the rpm of the motor detected by the rpm detector becomes equal to the target rpm; a step of starting the tracking servo; and a step of switching the motor rpm control from the control based on the rpm of the motor detected by the rpm detector to the control based on the signal read by the pickup. Therefore, it is possible to provide an optical disk drive control method which is able to change the rpm of the motor without moving the tracking position of the pickup.

Further, according to the present invention, there is provided a method for controlling an optical disk drive comprising a motor for rotationally driving an optical disk, a pickup for reading a signal from the optical disk, which is mounted movably with respect to the optical disk, and a rpm detector for detecting the rpm of the motor, and the optical disk drive performing tracking servo of the pickup and controlling the rpm of the motor on the basis of the signal read by the pickup when the optical disk is to be rotated at a constant rpm; and when the rpm of the optical disk is to be changed, the optical disk drive control method comprises a step of switching the motor rpm control from a control based on the signal read by the pickup to a control based on the rpm of the motor which is detected by the rpm detector; a step of turning off the focusing servo; a step of changing the rpm of the motor so that the rpm of the motor detected by the rpm detector becomes the target rpm; a step of starting the focusing servo; and a step of switching the motor rpm control from the control based on the rpm of the motor detected by the rpm detector to the control based on the signal read by the pickup. Therefore, it is possible to provide an optical disk drive control method which can change the rpm of the motor without moving the tracking position of the pickup, and reduce the load on the actuator as means for driving the pickup in the direction of the rotation axis of the motor.

### BRIEF DESCRIPTION OF THE DRAWINGS

FIG. 1 is a block diagram illustrating the construction of an optical disk drive according to a first embodiment of the present invention.

FIG. 2 is a flowchart for explaining a method of controlling the optical disk drive according to the first embodiment of the present invention.

FIG. 3 is a flowchart for explaining a method of controlling an optical disk drive according to a second embodiment of the present invention.

FIG. 4 is a flowchart for explaining a method of controlling the optical disk drive according to a third embodiment of the present invention.

FIG. 5 is a flowchart for explaining a method of controlling an optical disk drive according to a fourth embodiment of the present invention.

FIG. 6 is a flowchart for explaining a method of controlling a conventional optical disk drive.

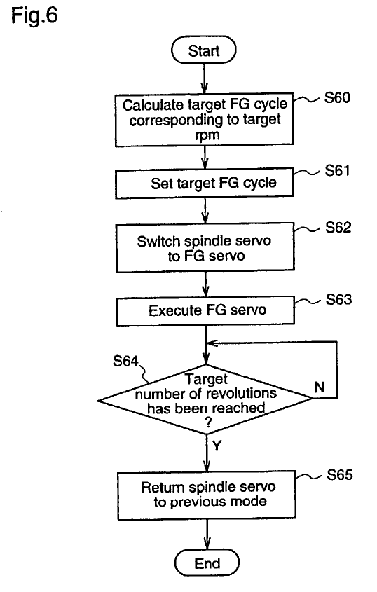

FIG. 7 is a block diagram illustrating the construction of an optical disk drive according to the second embodiment of the present invention.

FIG. 8 is a block diagram illustrating the construction of an optical disk drive according to the third embodiment of the present invention.

FIG. 9 is a block diagram illustrating the construction of an optical disk drive according to the fourth embodiment of the present invention.

### BEST MODE TO EXECUTE THE INVENTION

### Embodiment 1

In an optical disk drive according to a first embodiment of the present invention, the tracking servo is turned off while the rpm of a spindle motor is changed, thereby preventing a change in tracking positions before and after the change of the rpm of the spindle motor.

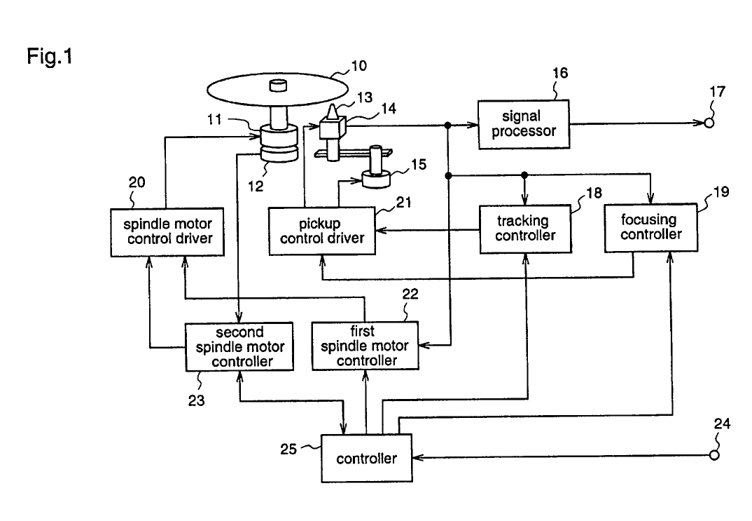

FIG. 1 is a block diagram illustrating the construction of an optical disk drive according to a first embodiment of the present invention. In FIG. 1, an optical pickup 13 is provided with a lens (not shown), and a signal is read from an optical disk 10, which is rotary-driven by a spindle motor 11, through this lens. The signal to be read is a WOBBLE signal or the like when no data is recorded on the optical disk 10. When data has already been recorded on the optical disk 10, the signal to be read from the disk 10 is a recorded signal including an EFM signal, or the like. A signal processor 16 processes the signal outputted from the optical pickup 13, extracts the recorded data from the optical disk 10, and outputs the data through an output terminal 17 to the outside.

The optical pickup 13 is mounted so that it can be moved by an actuator 14 in the direction of the rotational axis of the spindle motor 11, i.e., in the direction perpendicular to the data recording surface of the optical disk 10. Further, the optical pickup 13 is mounted so that it can be moved by a feed motor 15 in the direction of the radius of the optical disk 10. The optical pickup 13 can be moved in the direction of the radius of the optical disk 10 and in the direction of the rotation axis of the spindle motor 11, by driving the actuator 14 and the feed motor 15 with a pickup control driver 21, respectively. A tracking controller 18 controls the pickup control driver 21 so as to move the optical pickup 13 to a read position or a write position on the optical disk 10, and it performs tracking servo of the optical pickup 13 on the basis of the signal outputted from the optical pickup 13. That is, whether the tracking position of the optical pickup 13 is deviated or not is checked on the basis of the signal outputted from the optical pickup 13, and when the tracking position is deviated, the actuator 14 is driven by the pickup control driver 21 to move the optical pickup 13 in the direction of the radius of the optical disk 10 so that the tracking position is corrected. This control is called “tracking servo”. The focus controller 19 performs focusing servo on the basis of the signal outputted from the optical pickup 13. That is, whether the focus of the optical pickup 13 is deviated or not is checked on the basis of the signal outputted from the optical pickup 13, and when the focus is deviated, the actuator 14 is driven by the pickup control driver 21 to move the optical pickup 13 in the direction of the rotation axis of the spindle motor 11 so that the focus position is corrected. This control is called “focusing servo”.

The spindle motor control driver 20 for driving the spindle motor 11 is controlled by a first spindle motor controller 22 or a second spindle motor controller 23. The first spindle motor controller 22 detects the rpm of the optical disk 10, that is, the rpm of the spindle motor 11, from the WOBBLE signal or the EFM signal obtained from the optical pickup 13, and controls the spindle motor control driver 20 on the basis of the detected rpm so that the rpm of the spindle motor 11 reaches a predetermined rpm. In the vicinity of the spindle motor 11, a Hall element 12 is disposed as a means for detecting the rpm of the spindle motor 11. The Hall element 12 outputs an FG signal in accordance with the revolution of the spindle motor 11. This FG signal corresponds to the rpm of the spindle motor 11. The second spindle motor controller 23 controls the spindle motor control driver 20 so that the rpm of the spindle motor 11 reaches a predetermined rpm, on the basis of the rpm of the spindle motor 11, which is obtained from the FG signal outputted from the Hall element 12. Control of the rpm of the spindle motor 11 is called “spindle servo” and, particularly, control of the rpm of the spindle motor 11 by the first spindle motor controller 22 on the basis of the WOBBLE signal is called “WOBBLE servo”, control of the rpm of the spindle motor 11 by the first spindle motor controller 22 on the basis of the EFM signal is called “EFM servo”, and control of the rpm of the spindle motor 11 by the second spindle motor controller 23 on the basis of the FG signal is called “FG servo”.

A controller 25 performs control as follows, on the basis of a signal instructing the controller 25 to change the rpm of the spindle motor 11, which signal is supplied from an external device such as a host computer (not shown) through an input terminal 24. When the optical pickup 13 should be brought to a data reading position or writing position, the controller 25 instructs the tracking controller 18 to bring the optical pickup 13 to the desired position. When the spindle motor 11 should be rotated at a constant rpm, the controller 25 instructs the first spindle motor controller 22 to perform control for keeping the rpm of the spindle motor 11 constant, and instructs the tracking controller 18 and the focus controller 19 to perform tracking servo and focusing servo of the optical pickup 13, respectively. Further, while the rpm of the spindle motor 11 is changed, the controller 25 instructs the second spindle motor controller 23 to perform control for changing the rpm of the motor, and instructs the focus controller 19 to perform focusing servo of the optical pickup 13, and further, instructs the tracking controller 18 to turn off the tracking servo of the optical pickup, whereby no tracking servo is carried out.

Next, the operation of the optical disk drive for controlling the rpm will be described for the case where the rpm of the spindle motor 11 should be kept constant.

When a request for keeping the rpm constant is supplied from the host computer or the like through the input terminal 24 to the controller 25, the controller 25 instructs the first spindle motor controller 22 to keep the rpm constant. On receipt of this instruction, the first spindle motor controller 22 performs the WOBBLE servo on the basis of the WOBBLE signal in the case where no data is recorded on the optical disk 10, or performs the EFM servo on the basis of the EFM signal in the case where data has already been recorded on the optical disk 10, thereby controlling the spindle motor 11 so as to keep the rpm of the optical disk 10 constant. At this time, the controller 25 instructs the tracking controller 18 and the focusing controller 19 to perform tracking servo and focusing servo, respectively. On receipt of these instructions, the tracking controller 18 and the focusing controller 19 perform tracking servo and focusing servo of the optical pickup 13, respectively. The tracking servo and focusing servo are carried out to normally read the signals from the optical disk 10 because, as described in the section of BACKGROUND ART, the WOBBLE servo or EFM servo controls the spindle motor 11 on the basis of the signals read from the optical disk 10.

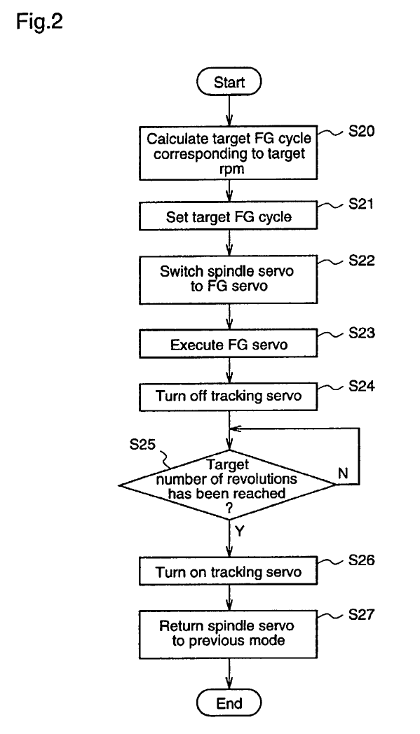

FIG. 2 is a flowchart illustrating the control operation for changing the rpm of the spindle motor 11, which operation is carried out by the controller 25, the first spindle motor controller 22, and the second spindle motor controller 23 included in the optical disk drive according to the first embodiment of the invention. Hereinafter, the case where the rpm of the spindle motor 11 is to be changed will be described with reference to FIG. 2.

Initially, when a request for changing the rpm is supplied from the host computer (not shown) through the input terminal 24 to the controller 25, the controller 25 calculates the cycle (i.e., frequency) of the FG signal corresponding to the target rpm (step S20). Next, the cycle obtained in step S20 is set as a target FG cycle, in the second spindle motor controller 23 for performing the FG servo (step S21). Next, the EFM servo or WOBBLE servo, which has been carried out by the first spindle motor controller 22, is turned off, and the spindle servo is switched to the FG servo by instructing the second spindle motor controller 23 to perform the FG servo (step S22), whereby the FG servo is carried out (step S23). Thereby, the spindle motor 11 starts to accelerate or decelerate the revolution toward the target rpm. Next, the controller 25 instructs the tracking controller 18 to turn off (i.e., cancel) the tracking servo (step S24). Thereby, the lens (not shown) of the optical pickup 13 does not follow the grooves formed on the optical disk 10 in the direction of the radius of the optical disk 10, but the lens remains at the position.

Next, the second spindle motor controller 23 checks whether the spindle motor 11 has reached the target rpm or not, on the basis of the FG signal obtained from the Hall element 12 and the target FG cycle (step S25). When the spindle motor 11 has reached the target rpm, the second spindle motor controller 23 notifies the controller 25 that the spindle motor 11 has reached the target rpm. On receipt of this notification, the controller instructs the tracking controller 18 to perform the tracking servo, and the tracking servo is turned on (step S26), whereby the optical pickup 13 resumes the operation of making the laser beam emitted from the lens of the optical pickup 13 follow the grooves formed on the optical disk 10 in the direction of the radius of the optical disk 10. Subsequently, the servo of the spindle motor 11 is switched from the servo by the second spindle motor controller 23 to the servo by the first spindle motor controller 22, whereby the spindle servo is returned from the FG servo back to the EFM servo or WOBBLE servo which had been carried out before step 22 (step S27).

As described above, in this first embodiment of the invention, when changing the rpm of the spindle motor 11, the controller 25 switches the spindle servo of the spindle motor 11 from the EFM servo or WOBBLE servo by the first spindle motor controller 22 to the FG servo by the second spindle motor controller 23 and, simultaneously, the controller 25 turns off the tracking servo by the tracking controller 18. Therefore, the spindle motor 11 is controlled by the FG servo and no tracking servo of the optical pickup 13 is carried out while the rpm is changed, whereby the rpm of the spindle motor can be changed without moving the tracking position. As the result, there is no change in the tracking positions before and after the change of the rpm of the spindle motor and, therefore, the recording state of the optical disk at the tracking position is not changed after the rpm change, and setting of the spindle servo after the rpm change is normally carried out, resulting in stable recording/playback operation.

Furthermore, the FG servo is carried out on the basis of the FG signal which is outputted from the Hall element 12 in accordance with the rpm of the spindle motor 11. Accordingly, the signals read from the optical disk 10 are not required for the FG servo and, therefore, no problem occurs in the spindle servo even though the tracking servo of the optical pickup is not carried out during execution of the FG servo.

Furthermore, when the spindle servo is changed to the FG servo after the tracking servo is turned off, there may temporarily occur a state where the tracking servo is turned off although the WOBBLE servo or EFM servo which needs the tracking servo is carried out, immediately after the turn-off of the tracking servo. In this state, normal spindle servo cannot be carried out, and stable recording/playback operation cannot be carried out. In the first embodiment of the invention, however, since the tracking servo is turned off after the spindle servo is changed to the FG servo which does not need the tracking servo, such problem hardly occur, resulting in stable recording/playback operation.

Moreover, since the focusing servo is carried out even while the rpm of the spindle motor 11 is changed, the focusing servo is surely carried out when the tracking servo is resumed after the rpm of the spindle motor is changed, whereby the tracking servo can be resumed easily and speedily.

### Embodiment 2

In an optical disk according to a second embodiment of the present invention, focusing servo is turned off while the rpm of the spindle motor is changed, whereby there occurs no change in tracking positions before and after the change of the rpm of the spindle motor, and the load on the actuator which drives the optical pickup 13 in the direction of the rotation axis is reduced.

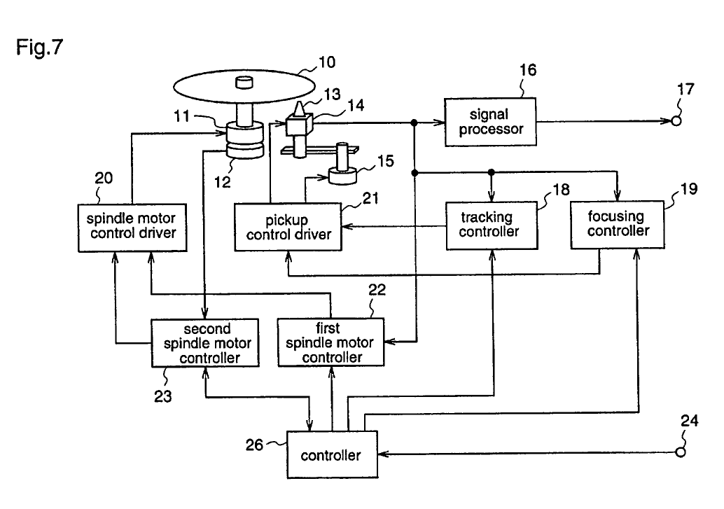

FIG. 7 is a block diagram illustrating the construction of an optical disk drive according to the second embodiment of the present invention. In FIG. 7, the same reference numerals as those shown in FIG. 1 denote the same or corresponding parts. The optical disk drive according to this second embodiment is different from the optical disk drive according to the first embodiment in that a controller 26 is provided instead of the controller 25.

The controller 26 performs control as described in the following, on the basis of a signal which is supplied from the outside through the input terminal 24 and instructs the controller 26 to change the rpm of the spindle motor 1. When the optical pickup 13 should be moved to a data reading position or writing position, the controller 26 instructs the tracking controller 18 to move the optical pickup 13 to the desired position. When the spindle motor 11 should be rotated at a constant rpm, the controller 26 instructs the first spindle motor controller 22 to keep the rpm of the spindle motor constant, and instructs the tracking controller 18 and the focusing controller 19 to perform tracking servo and focusing servo of the optical pickup 13, respectively. Further, while the rpm of the spindle motor 11 is changed, the controller 26 instructs the second spindle motor controller 23 to perform control for changing the rpm of the spindle motor 11, and instructs the focusing controller 19 to turn off the focusing servo of the optical pickup 13, whereby no focusing servo is carried out.

Next, the operation of the optical disk drive for controlling the rpm will be described. Since the operation of the drive when the rpm of the spindle motor 11 should be kept constant is identical to that already described for the first embodiment, it will be omitted in this second embodiment.

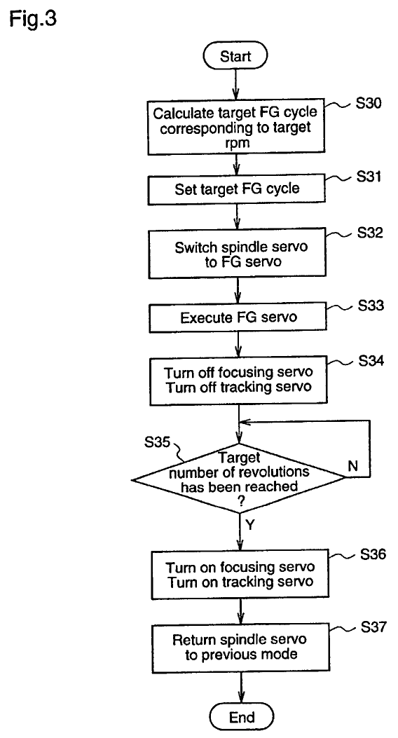

FIG. 3 is a flowchart illustrating the control operation when the rpm of the spindle motor 11 is changed by the controller 26, the first spindle motor controller 22, and the second spindle motor controller 23 of the optical disk drive according to the second embodiment of the invention. Hereinafter, a description will be given of the case where the rpm of the spindle motor 11 is changed, with reference to FIG. 3.

Initially, when a request for changing the rpm is supplied from a host computer or the like through the input terminal 24 to the controller 26, the controller 26 calculates the cycle of the FG signal corresponding to a target rpm (step S30). Next, the target FG cycle obtained in step S30 is set in the second spindle motor controller 23 for performing the FG servo (step S31). Next, the controller 26 turns the EFM servo or WOBBLE servo off, i.e., the spindle servo which has been performed by the first spindle motor controller 22, and instructs the second spindle motor controller 23 to perform the spindle servo, whereby the spindle servo is switched to the FG servo (step S32), and the FG servo is executed (step S33). Then, the spindle motor 11 starts to accelerate or decelerate the revolution toward the target rpm.

Next, the controller 26 instructs the focusing controller 19 to turn the focusing servo off (step S34). Thereby, the lens of the optical pickup 11 stops the following of the grooves formed on the optical disk 10 in the direction of the rotation axis, whereby the laser beam cannot be focused on the optical disk. Accordingly, also tracking servo becomes uncontrollable, and the lens of the optical pickup 11 remains at the position.

Next, the second spindle motor controller 23 checks whether the spindle motor 11 has reached the target rpm or not, on the basis of the FG signal obtained from the Hall element 12 (step S35). When the spindle motor 11 has reached the target rpm, the second spindle motor controller 23 notifies the controller 26 that the spindle motor 11 has reached the target rpm. On receipt of this notification, the controller 26 instructs the focusing controller 19 to start the focusing servo, and the focusing servo is turned on (step S36), thereby resuming the operation of following the grooves formed on the optical disk 10, with the laser beam emitted from the lens of the optical pickup 13. Subsequently, the servo of the spindle motor 11 is switched from the servo by the second spindle motor controller 23 to the servo by the first spindle motor controller 22, whereby the spindle servo is returned from the FG mode to the EFM servo or WOBBLE servo which had been set before step 32.

In the optical disk drive according to the second embodiment, when changing the rpm of the spindle motor 11, the controller 26 switches the spindle servo from the EFM servo or WOBBLE servo by the first spindle motor controller 22 to the FG servo by the second spindle motor controller 23, and the controller 26 turns the focusing servo off by the focusing controller 19 so that no focusing servo of the optical pickup 13 is carried out while the rpm is changed. Since no focusing servo is carried out, also the tracking servo is not carried out while the rpm is changed. As the result, the rpm of the spindle motor 11 can be changed without moving the tracking position, and the same effects as described for the first embodiment can be achieved.

Further, since the grooves are spirally formed on the optical disk, while the rpm is changed when the focusing servo is carried out, the laser beam emitted from the optical pickup is required to intensively follow the grooves in the direction of the rotation axis. As the result, a great load is put on the actuator that drives the lens of the optical pickup in the direction of the rotation axis. In this second embodiment, however, since no focusing servo is carried out while the rpm is changed, the load on the actuator 14 that drives the optical pickup 13 can be reduced.

Further, when the spindle servo is changed to the FG servo after the focusing servo is turned off, there may temporarily occur a state where the tracking servo and focusing servo are turned off although the WOBBLE servo or EFM servo which needs the tracking servo and focusing servo is carried out, immediately after the turn-off of the tracking servo. In this state, normal spindle servo cannot be carried out, and stable recording/playback operation cannot be achieved. In this second embodiment, however, since the focusing servo is turned off after the spindle servo is changed to the FG servo that does not need the tracking servo, such problem hardly occur, resulting in stable recording/playback operation.

In this second embodiment, not the tracking servo but the focusing servo is turned off while the rpm of the spindle motor 11 is changed. In the present invention, however, the tracking servo by the tracking controller 18 may be turned off before turning off the focusing servo in step S34 shown in FIG. 3, and the focusing servo and tracking servo may be turned on in step S36. In this way, after the tracking servo is turned off to stop the tracking of the lens of the optical pickup 13 on the grooves formed on the optical disk 10 in the direction of the radius, the focusing servo is turned off in step S34, whereby the same effects as mentioned for the second embodiment are achieved, and the tracking of the laser beam emitted from the optical pickup 13 on the grooves on the optical disk 10 in the direction of the radius of the optical disk 10 can be stopped with higher reliability.

### Embodiment 3

In an optical disk drive according to a third embodiment of the present invention, tracking servo is turned off when the rpm of the spindle motor should be changed, and whether focusing servo should be turned off or not is decided according to the rpm of the optical disk. Thereby, there occurs no change in tracking positions before and after the change of the rpm of the spindle motor, and the load on the actuator can be reduced without increasing the process and time required for turn-off and resumption of focusing servo.

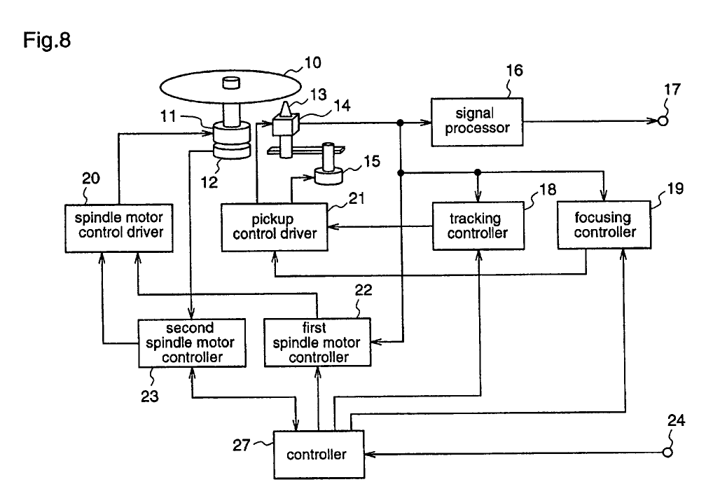

FIG. 8 is a block diagram illustrating the construction of an optical disk drive according to a third embodiment of the present invention. In FIG. 8, the same reference numerals as those shown in FIG. 1 denote the same or corresponding parts. The optical disk drive according to the third embodiment is different from the optical disk drive according to the first embodiment in that a controller 27 is provided instead of the controller 25.

The controller 27 performs control as follows, on the basis of a signal which is supplied from the outside through the input terminal 24 and instructs the controller 27 to change the rpm of the spindle motor 11. When the optical pickup 13 should be moved to a data reading position or writing position, the controller 27 instructs the tracking controller 18 to move the optical pickup 13 to the desired position. When the spindle motor 11 should be rotated at a constant rpm, the controller 27 instructs the first spindle motor controller 22 to keep the rpm of the spindle motor 11 constant, and instructs the tracking controller 18 and the focusing controller 19 to perform tracking servo and focusing servo of the optical pickup 13, respectively. Further, while the rpm of the spindle motor 11 is changed, the controller 27 instructs the second spindle motor controller 23 to perform control for changing the rpm of the motor, and instructs the tracking controller 18 to turn off the tracking servo of the optical pickup 13 so that no tracking servo is carried out. Further, the controller 27 decides whether the focusing servo of the optical pickup 13 by the focusing controller 19 should be turned off or not, on the basis of the absolute value of a difference between the target rpm of the spindle motor 11, and the rpm before being changed, which is obtained from the Hall element 12 through the second spindle motor controller 23. Then, on the basis of the decision, the controller 27 instructs the focus controller 19 to turn off or continue the focusing servo.

Next, the operation of the optical disk drive for controlling the rpm will be described. Since the operation of the drive when the rpm of the spindle motor 11 should be kept constant is identical to that described for the first embodiment, it will be omitted in this third embodiment.

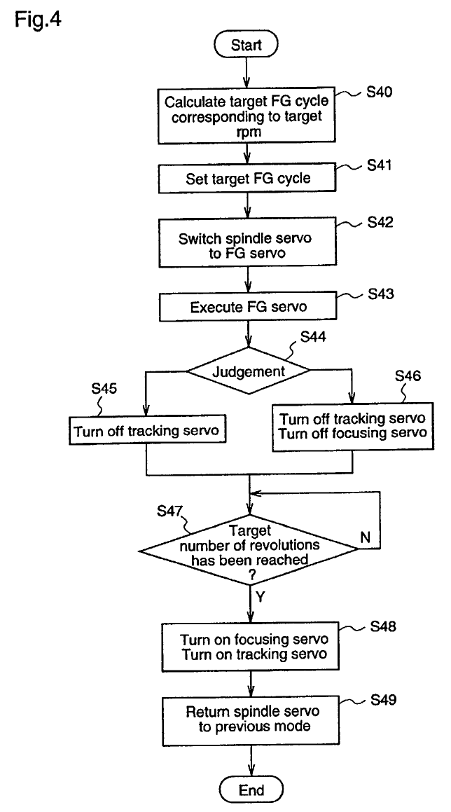

FIG. 4 is a flowchart illustrating the control operation when changing the rpm of the spindle motor 11 by the controller 27, the first spindle motor controller 22, and the second spindle motor controller 23 which are included in the optical disk drive according to the third embodiment of the invention. Hereinafter, a description will be given of the case where the rpm of the spindle motor 11 is changed, with reference to FIG. 4.

Initially, when a request for changing the rpm is supplied from the host computer or the like through the input terminal 24 to the controller 27, the controller 27 calculates the cycle of the FG signal corresponding to a target rpm (step S40). Next, the target FG cycle obtained in step S40 is set in the second spindle motor controller 23 which performs the FG servo (step S41). Next, the controller 27 turns off the EFM servo or WOBBLE servo, i.e., the spindle servo which has been carried out by the first spindle motor controller 22, and instructs the second spindle motor controller 23 to perform the spindle servo, thereby switching the spindle servo to the FG servo (step S42), and the FG servo is executed (step S43). Thereby, the spindle motor 11 starts to accelerate or decelerate the revolution toward the target rpm.

Next, either turn-off of only tracking servo or turn-off of both tracking servo and focusing servo is branch-decided (step S44), selected, and executed. That is, it is decided whether turn-off of focusing servo should be performed or not, in addition to turn-off of tracking servo. When only the tracking servo is turned off while performing the focusing servo during changing of the rpm of the spindle motor 11, the laser beam emitted from the optical pickup 13 does not follow the grooves formed on the optical disk 10 in the direction of the radius, but follows the grooves in the direction of the rotation axis. Since the grooves are spirally formed on the optical disk, the laser beam emitted from the optical pickup is forced to intensively follow the grooves in the direction of the rotation axis. As the result, a great load is put on the actuator that drives the lens of the optical pickup. However, the process and time required for turn-off and resumption of focusing servo are not increased. On the other hand, when both of tracking servo and focusing servo are turned off, since the laser beam emitted from the optical pickup does not follow the grooves in the direction of the radius of the optical disk as well as in the direction of the rotation axis, no load is put on the actuator. However, the process and time required for turn-off and resumption of focusing servo are increased. That is, when the focusing servo, which has once been turned off, is resumed, the focusing servo might not operate normally due to flaws on the optical disk or the like. In this case, it is necessary to repeat the focusing servo starting operation until the focusing servo is normally resumed, or it takes much time to turn off and resume the focusing servo, whereby the time required for changing the rpm of the spindle motor 11 is increased. Hereinafter, a description will be given of the branch decision of the two types of servo turn-off (step S44).

Initially, the controller 27 calculates a difference between the rpm of the spindle motor 11 before it is changed, and the target rpm. Then, the absolute value of this difference is compared with a predetermined threshold. When the absolute value of the difference is smaller than the threshold, only the tracking servo is turned off (step S45). Further, when the absolute value of the difference is equal to or larger than the threshold, the focusing servo as well as the tracking servo are turned off (step S46).

Therefore, when the rpm of the spindle motor 11 is substantially changed, i.e., when the absolute value of the difference between the rpm of the spindle motor 11 before being changed and the target rpm is equal to or larger than the threshold, the load on the actuator 14 can be reduced by turning both of tracking servo and focusing servo off.

Further, when the rpm of the spindle motor 11 is not substantially changed, i.e., when the absolute value of the difference between the rpm of the spindle motor 11 before being changed and the target rpm is smaller than the threshold, since the load on the actuator 14 is relatively small, the process and time required for turn-off and resumption of the focusing servo can be reduced by turning only the tracking servo off. Accordingly, a reduction in the load on the actuator 14 is realized by the relatively simple process of comparing the amount of change in the rpm with the threshold. As for the threshold, a value most suited to the performance of the optical disk should be obtained in advance, according to the difference in the rpm that is required for changing the rpm of the optical disk 10, by calculation or simulation, considering the influence of ON/OFF of the focusing servo on the performance of the optical disk.

Next, the second spindle motor controller 23 checks whether the spindle motor 11 has reached the target rpm or not, on the basis of the FG signal obtained from the Hall element 12 (step S47). When the spindle motor 11 has reached the target rpm, the second spindle motor controller 23 notified the controller 27 that the spindle motor 11 has reached the target rpm. On receipt of this notification, the controller 27 instructs the focusing controller 19 to turn on the focusing servo if the focusing servo is not carried out during changing of the rpm. Further, the controller 27 also instructs the tracking controller 18 to turn on the tracking servo (step S48), thereby resuming the operation in which the laser beam emitted from the lens of the optical pickup follows the grooves formed on the optical disk. Subsequently, the servo of the spindle motor 11 is switched from the servo by the second spindle motor controller 23 to the servo by the first spindle motor controller 22, whereby the spindle servo is returned from the FG mode to the EFM servo or WOBBLE servo that had been carried out before step S42 (step S49).

In the optical disk drive according to the third embodiment of the invention, when changing the rpm of the spindle motor 11, the controller 27 switches the spindle servo from the EFM servo or the WOBBLE servo performed by the first spindle motor controller 22 to the FG servo performed by the second spindle motor controller 23, and the controller 27 turns off the tracking servo by the tracking controller 18 so that no tracking servo of the optical pickup 13 is carried out while the rpm is changed. Therefore, no tracking servo of the optical pickup 13 is carried out during changing of the rpm, whereby the same effects as those described for the first embodiment are achieved.

Furthermore, the absolute value of a difference between the rpm of the spindle motor before being changed and the target rpm is compared with a predetermined threshold by the controller 27, and when the absolute value of the difference is equal to or larger than the threshold value, the focusing servo by the focusing controller 19 is turned off, and when it is smaller than the threshold value, the focusing servo is continued. Thereby, when the rpm of the spindle motor 11 is substantially changed, the load on the actuator 14 can be reduced by turning the focusing servo off. Further, when the rpm of the spindle motor 11 is not substantially changed, the focusing servo is not turned off because the load on the actuator 14 is relatively small, whereby the process and time required for turn-off and resumption of the focusing servo are reduced. Accordingly, the selection as to whether the focusing servo is turned off or not is carried out so that optimum result for the optical disk drive is achieved, by the relatively simple process of comparing the amount of change in the rpm with the threshold, considering the influence of increases in the required process and time when the focusing servo is turned off, on the optical disk drive as well as the influence of the load on the actuator 14 when the focusing servo is not turned off, on the optical disk drive, whereby the load on the actuator 14 can be reduced without increasing the process and time required for turn-off and resumption of the focusing servo.

While in this third embodiment turn-off or continuation of focusing servo is decided on the basis of the amount of change in the rpm in step S44, it may be decided on the basis of the time required for changing the rpm of the spindle motor 11. Hereinafter, a description will be given of the case where turn-off or continuation of focusing servo is decided according to the time required for changing the rpm.

The controller 27 obtains, in advance, the relationship between the amount of change in the rpm of the spindle motor 11 and the time required for this change, and compares the current rpm with the target rpm on the basis of this result to derive the time required for changing the rpm. When the required time is smaller than a predetermined threshold, the controller 27 instructs the tracking controller 18 to turn off the tracking servo only (step S45), and when the required time is equal to or larger than the threshold, the controller 27 instructs the tracking controller 18 and the focusing controller 19 to turn off the tracking servo and the focusing servo, respectively (step S46).

The load on the actuator 14 relating to driving of the lens of the optical pickup 13 is in proportion to the time during which only the tracking servo is turned off. For example, between the case where the rpm of the spindle motor 11 is increased from 24X to 32X and the case where the rpm is decreased from 32X to 24X, although these cases have the same absolute value of the difference between the rpm of the spindle motor before being changed and the target rpm, the time required for changing the rpm is usually longer in the case of increasing the rpm than in the case of decreasing the rpm. Accordingly, the relationship between the amount of change in the rpm of the spindle motor and the time required for the change is previously measured for both cases of increasing and decreasing the rpm, and the required times are stored. Then, the time required for changing the current rpm of the spindle motor is derived using the result, and the derived time is compared with a threshold value that has previously been obtained so as to be an optimum value for the performance of the optical disk drive, considering the influence of ON/OFF of the focusing servo according to the time for changing the rpm, on the performance of the optical disk, whereby it is decided whether the focusing servo is turned off or continued. Although a decision process a little complicated as compared with the decision process in step S44 is required by performing this step instead of step S44, the load on the actuator when the focusing servo is not turned off can be decided more accurately, and selection as to whether the focusing servo is to be turned off or not can be carried out more appropriately, whereby the load on the actuator can be reduced with reliability without increasing the process and time required for turn-off and resumption of focusing servo.

### Embodiment 4

In an optical disk drive according to a fourth embodiment of the present invention, focusing servo is turned off when changing the rpm of the spindle motor, and it is resumed before the spindle motor reaches the target rpm. Thereby the time from when the spindle motor reaches the target rpm to when the focusing servo is operated, which time is required for keeping the rpm of the optical disk constant, is reduced, whereby the time required for changing the rpm of the spindle motor can be reduced.

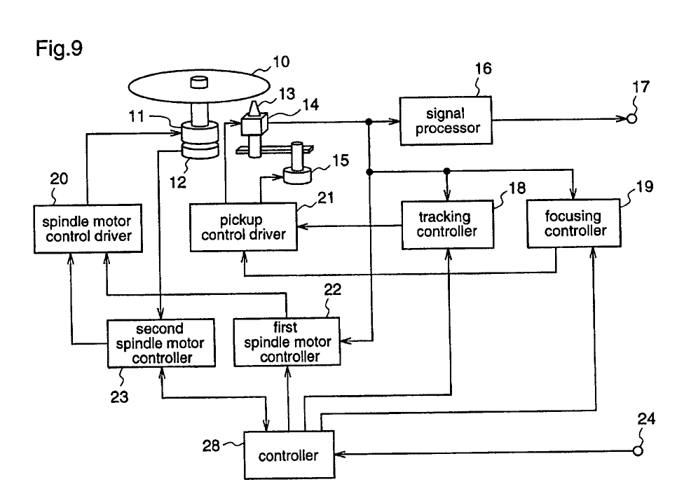

FIG. 9 is a block diagram illustrating the construction of an optical disk drive according to a fourth embodiment of the present invention. In FIG. 9, the same reference numerals as those shown in FIG. 1 denote the same or corresponding parts. The optical disk drive according to this fourth embodiment is different from the optical disk drive according to the first embodiment in that a controller 28 is provided instead of the controller 25.

The controller 28 performs control as follows, on the basis of a signal instructing the controller 28 to change the rpm of the spindle motor 11, which signal is supplied from the outside through the input terminal 24. When the optical pickup 13 should be moved to a data reading position or writing position, the controller 28 instructs the tracking controller 18 to move the optical pickup 13 to the desired position. When the spindle motor 11 should be rotated at a constant rpm, the controller 28 instructs the first spindle motor controller 22 to perform control for keeping the rpm of the spindle motor 11 constant, and instructs the tracking controller 18 and the focusing controller 19 to perform tracking servo and focusing servo of the optical pickup 13, respectively. Further, while the rpm of the spindle motor 11 is changed, the controller 28 instructs the second spindle motor controller 23 to perform control for changing the rpm of the motor, and instructs the focusing controller 19 to turn off the focusing servo of the optical pickup 13 so that no focusing servo is carried out, and instructs the focusing controller 19 to resume the focusing servo before the spindle motor 11 reaches the target rpm.

Next, the operation of the optical disk drive for controlling the rpm will be described. Since the operation of the drive when the rpm of the spindle motor 11 is kept constant is identical to that described for the first embodiment, it will be omitted in this fourth embodiment.

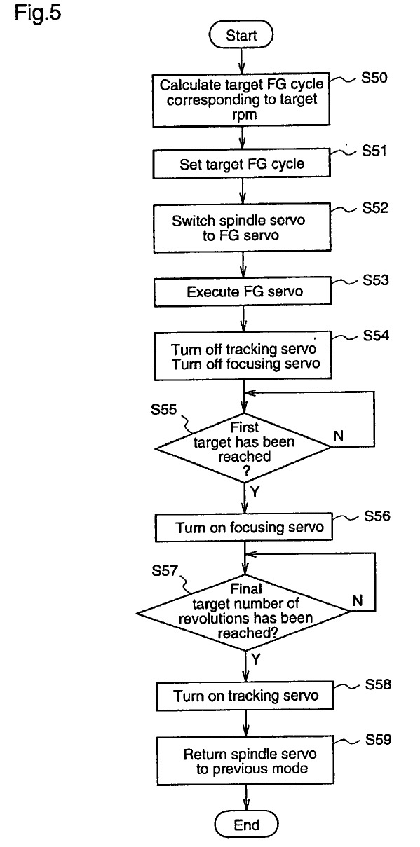

FIG. 5 is a flowchart illustrating the control operation of the drive when the rpm of the spindle'motor 11 is changed by the controller 28, the first spindle motor controller 22, and the second spindle motor controller 23, which are included in the optical disk drive according to the fourth embodiment. Hereinafter, a description will be given of the case where the rpm of the spindle motor 11 is changed, with reference to FIG. 5.

Initially, when a request for changing the rpm is outputted from a host computer or the like, the controller 28 calculates the cycle of the FG signal corresponding to the target rpm (step S50). Next, the controller 28 sets the target FG cycle obtained in step S50, in the second spindle motor controller 23 that performs FG servo (step S51). Next, the controller 28 changes the spindle servo, which has been executed by the EFM servo or WOBBLE servo of the first spindle motor controller 22, to the FG servo of the second spindle motor controller 23 (step S52), whereby the FG servo is carried out by the second spindle motor controller 23 (step S53). Thereby, the spindle motor 11 starts to accelerate or decelerate the revolution toward the target rpm. Next, the controller 28 instructs the tracking controller 18 and the focusing controller 19 to turn off the tracking servo and the focusing servo, respectively (step S54), whereby the lens of the optical pickup 13 stops the following of the grooves in the direction of the radius of the optical disk 10 and in the direction of the rotation axis of the optical disk 10, and the lens remains at that position.

The controller 28 multiplies the target rpm of the spindle motor 11 to be obtained after changing the rpm, by a predetermined number, to obtain a predetermined rpm (hereinafter referred to as a first target), and sets this first target in the second spindle motor controller 23. The predetermined number should be selected so that the first target is positioned before the target rpm. The second spindle motor controller 23 checks whether the rpm of the spindle motor 11 has reached the first target or not, on the basis of the FG signal obtained from the Hall element 12 (step S55).

Subsequently, when the rpm of the spindle motor 11 has reached the first target, the focusing servo is turned on. That is, according to an instruction from the controller 28, the focusing controller 19 turns on the focusing servo, during rotation of the spindle motor 11, before the spindle motor 11 reaches the target rpm (step S56). Thereby, the first target at which the focusing servo is to be started can be obtained by the simple process of multiplying the target rpm by a predetermined number. By resuming the focusing servo at this first target, the focusing servo can be resumed before the spindle motor 11 reaches the target rpm. Therefore, as compared with the case where the focusing servo is resumed after the spindle motor 11 has reached the target rpm and the optical disk 10 is rotated at a constant rpm by the WOBBLE servo or EFM servo, the time required until the focusing servo goes into normal operation is reduced, whereby the time required for changing the rpm of the spindle motor 11 can be reduced. Further, although the lens of the optical pickup 13 starts the following in the direction of the rotation axis of the optical disk 10, it does not perform the following in the direction of the radius of the optical disk 10 because the tracking servo is off at this point of time. Accordingly, during this operation, the tracking position does not change.

Next, the second spindle motor controller 23 checks whether the spindle motor 13 has reached the final target rpm or not, on the basis of the FG signal obtained from the Hall element 12 (step S57). When the spindle motor 13 has reached the final target rpm, the second spindle motor controller 23 notifies the controller 28 that the spindle motor 13 has reached the final target rpm. On receipt of this notification, the controller 28 instructs the tracking controller 18 to turn on the tracking servo (step S58). Subsequently, the controller 28 changes the spindle servo from the FG mode to the mode which had been carried out before step 52 (step S59).

In the optical disk drive according to the fourth embodiment, when changing the rpm of the spindle motor 11, the controller 28 switches the spindle servo from the EFM servo or WOBBLE servo by the first spindle motor controller 22 to the FG servo by the second spindle motor controller 23, and the controller 27 turns of the tracking servo and the focusing servo by the tracking controller 18 and the focusing controller 19 so that the optical pickup 13 does not perform the tracking servo and focusing servo when the rpm is changed, whereby the same effects as described for the first and second embodiments are achieved.

Furthermore, the target rpm of the spindle motor 11 is multiplied by a predetermined number to obtain a first target that is positioned before the target rpm, and the focusing servo is performed when the rpm of the spindle motor 11 reaches the first target. Thereby, the first target at which the focusing servo should be started can be obtained by the simple process of multiplying the target rpm by a predetermined number, and the change of the rpm of the spindle motor 11 and the focusing servo operation are carried out simultaneously by starting the focusing servo at this first target. Therefore, as compared with the case where the focusing servo is started after the spindle motor 11 has reached the target rpm and the optical disk 10 is rotated at a constant rpm by the WOBBLE servo or EFM servo, the time required until the focusing servo goes into operation, which time is required for keeping the rpm of the optical disk 10 constant, is reduced, whereby the time required for changing the rpm of the spindle motor 11, i.e., the time required from when the rpm change is started to when the spindle motor is rotated at a constant rpm, can be reduced.

Furthermore, in the fourth embodiment, the focusing servo is resumed when changing the rpm, on the basis of the first target that is obtained by multiplying the target rpm by a predetermined number. In the present invention, however, the following process may be performed instead of step S55. That is, the time required for changing the rpm of the spindle motor 11 from the start of this change is previously calculated by the controller 28, and a predetermined time is subtracted from the required time to obtain a first target, and it is decided whether the rpm has reached this first target or not. When the rpm has reached the first target, the focusing servo is turned on in step S56. The predetermined time to be subtracted from the required time is the time required from when the focusing servo is started to when the focusing servo goes into the normal state, and this time is approximately constant. Accordingly, the time required for the focusing servo operation is subtracted from the time required for changing the rpm of the spindle motor 11, and the time so calculated is used as the focusing servo starting time, whereby the rpm change completion time coincides with the focusing operation completion time, and the time during which the focusing servo is carried out while changing the rpm of the spindle motor 11 can be minimized.

While in the first to fourth embodiments the spindle motor and the pickup are controlled using the tracking controller 18, the focusing controller 19, the first spindle motor controller 22, the second spindle motor controller 23, and the controllers 25 to 28, in the present invention these controllers may be implemented by a single controller or plural controllers. Also in this case, the same effects as those described for the first to fourth embodiments are achieved.

Further, in the present invention, these controllers may be implemented by a CPU (Central Processing Unit), and the spindle motor and the pickup may be controlled by software. Also in this case, the same effects as those described for the first to fourth embodiments are achieved.

### APPLICABILITY IN INDUSTORY

As described above, the optical disk drive and the method for controlling the optical disk drive according to the present invention are suitable as an optical disk drive and an optical disk drive control method for playing or playing and recording optical disks such as CD-ROM, CD-RW, DVD (Digital Versatile Disc) and the like.

1. An optical disk drive comprising:
a motor for rotationally driving an optical disk;
a pickup for reading a signal from the optical disk, said pickup being mounted movably with respect to the optical disk;
a rpm detector for detecting the rpm of the motor;
a tracking control means for performing tracking servo of the pickup on the basis of the signal which is read by the pickup;
a first motor control means for detecting the rpm of the motor from the signal read by the pickup, and controlling the rpm of the motor on the basis of the detected rpm;
a second motor control means for controlling the rpm of the motor on the basis of the rpm which is detected by the rpm detector; and
a control means for, when the rpm of the motor is to be kept constant, making the first motor control means perform a control for keeping the rpm of the motor constant, and making the tracking control means perform the tracking servo of the pickup, and when the rpm of the motor is to be changed, said control means making the second motor control means perform a control for changing the rpm of the motor, and making the tracking control means turn off the tracking servo of the pickup while the rpm is being changed.

2. An optical disk drive as defined in claim 1, wherein said control means turns off the tracking servo performed by the tracking control means, after the motor rpm control is switched from the control by the first motor control means to the control by the second motor control means.

3. An optical disk drive as defined in claim 1 further comprising:
a focusing control means for performing focusing servo of the pickup on the basis of the signal which is read by the pickup;
wherein said control means makes the focusing control means perform the focusing servo of the pickup when the rpm of the motor is to be kept constant or when the rpm of the motor is to be changed.

4. An optical disk drive as defined in claim 1 further comprising:
a focusing control means for performing focusing servo of the pickup on the basis of the signal which is read by the pickup;
wherein, when the rpm of the motor is to be kept constant, said control means makes the focusing control means perform the focusing servo of the pickup, and when the rpm of the motor is to be changed, said control means decides whether the focusing control means should perform the focusing servo or turn off the focusing servo while the rpm is being changed, according to the condition of the rpm of the optical disk, and then instructs the focusing control means to perform the decided operation.

5. An optical disk drive as defined in claim 4, wherein said control means decides whether the focusing control means should perform the focusing servo or turn off the focusing servo, on the basis of the absolute value of a difference between the rpm of the motor before being changed and the target rpm.

6. The optical disk drive as defined in claim 4, wherein said control means decides whether the focusing control means should perform the focusing servo or turn off the focusing servo, on the basis of the time required for changing the rpm of the motor.

7. An optical disk drive comprising:
a motor for rotationally driving an optical disk;
a pickup for reading a signal from the optical disk, said pickup being mounted movably with respect to the optical disk;
a rpm detector for detecting the rpm of the motor;
a focusing control means for performing focusing servo of the pickup on the basis of the signal which is read by the pickup;
a first motor control means for detecting the rpm of the motor from the signal read by the pickup, and controlling the rpm of the motor on the basis of the detected rpm;
a second motor control means for controlling the rpm of the motor on the basis of the rpm detected by the rpm detector; and
a control means for, when the rpm of the motor is to be kept constant, making the first motor control means perform a control for keeping the rpm of the motor constant, and making the focusing control means perform the focusing servo of the pickup; and when the rpm of the motor is to be changed, said control means making the second motor control means perform a control for changing the rpm of the motor, and making the focusing control means to turn off the focusing servo of the pickup while the rpm is being changed.

8. An optical disk drive as defined in claim 7, wherein said control means turns off the focusing servo performed by the focusing control means after the motor rpm control is switched from the control by the first motor control means to the control by the second motor control means.

9. An optical disk drive as defined in claim 7 further comprising:
a tracking control means for performing tracking servo of the pickup on the basis of the signal which is read by the pickup;
wherein, when the rpm of the motor is to be kept constant, said control means makes the tracking control means perform the tracking servo of the pickup; and when the rpm of the motor is to be changed, said control means switches the motor control from the control by the first motor control means to the control by the second motor control means, and then makes the tracking control means turn off the tracking servo of the pickup and, thereafter, makes the focusing control means turn off the focusing servo.

10. An optical disk drive as defined in claim 7, wherein said control means makes the focusing control means turn off the focusing servo when the rpm of the motor is to be changed, and makes the focusing control means resume the focusing servo before the motor reaches the target rpm.

11. An optical disk drive as defined in claim 10, wherein said control means sets a point of time when the focusing control means should start the focusing servo, at a point of time when the rpm of the motor being changed is equal to a rpm which is obtained by multiplying the target rpm-by a predetermined number and is positioned between the rpm before being changed and the target rpm.

12. An optical disk drive as defined in claim 10, wherein said control means decides the point of time when the focusing control means should start the focusing servo, on the basis of the time required until the rpm of the motor reaches the target rpm.

13. A method for controlling an optical disk drive comprising a motor for rotationally driving an optical disk, a pickup for reading a signal from the optical disk, which is mounted movably with respect to the optical disk, and a rpm detector for detecting the rpm of the motor, and said optical disk drive performing tracking servo of the pickup and controlling the rpm of the motor on the basis of the signal read by the pickup when the optical disk is to be rotated at a constant rpm, and
when the rpm of the optical disk is to be changed, said optical disk drive control method comprising:
a step of switching the motor rpm control from a control based on the signal read by the pickup to a control based on the rpm of the motor which is detected by the rpm detector;
a step of turning off the tracking servo;
a step of changing the rpm of the motor so that the rpm of the motor detected by the rpm detector becomes equal to the target rpm;
a step of starting the tracking servo; and
a step of switching the motor rpm control from the control based on the rpm of the motor detected by the rpm detector to the control based on the signal read by the pickup.

14. A method for controlling an optical disk drive comprising a motor for rotationally driving an optical disk, a pickup for reading a signal from the optical disk, which is mounted movably with respect to the optical disk, and a rpm detector for detecting the rpm of the motor, and said optical disk drive performing tracking servo of the pickup and controlling the rpm of the motor on the basis of the signal read by the pickup when the optical disk is to be rotated at a constant rpm, and
when the rpm of the optical disk is to be changed, said optical disk drive control method comprising:
a step of switching the motor rpm control from a control based on the signal read by the pickup to a control based on the rpm of the motor which is detected by the rpm detector;
a step of-turning off the focusing servo;
a step of changing the rpm of the motor so that the rpm of the motor detected by the rpm detector becomes the target rpm;
a step of starting the focusing servo; and
a step of switching the motor rpm control from the control based on the rpm of the motor detected by the rpm detector to the control based on the signal read by the pickup.
